(19) United States
(12) Patent Application Publication
(10) Pub. No.: US 2025/0093687 A1
(43) Pub. Date: Mar. 20, 2025

(54) METHOD FOR MAINTAINING A GLASSES FRAME

(71) Applicant: LUXOTTICA S.R.L., Agordo (BL) (IT)

(72) Inventors: Filippo BONFARNUZZO, San Vendemiano (TV) (IT); Alessandro DONOLI, Agordo (BL) (IT)

(21) Appl. No.: 18/294,413

(22) PCT Filed: Jul. 29, 2022
(86) PCT No.: PCT/IB2022/057038

§ 371 Date: Feb. 1, 2024

(30) Foreign Application Priority Data
Aug. 2, 2021 (IT) 102021000020687

(51) Int. Cl. G02C 13/00

(52) U.S. Cl. CPC G02C 13/001

(57) ABSTRACT

A method for maintaining a glasses frame includes the steps of: performing a scanning of the glasses frame, wherein scanning measures at least one characteristic of the glasses frame in a list including a front curve-face form angle, a pantoscopic angle, a curling of a temple curl, a maximum opening temple angle, a temple wrap; saving in a data file the at least one characteristic of the frame as a first configuration if it is an optimal configuration of the frame, or as a second configuration if it is a modified configuration of the frame; comparing the first configuration with the second configuration; analysing the two configurations and determining the differences; and indicating problems detected between the two configurations providing indications on how to solve them.

### CROSS-REFERENCE TO RELATED APPLICATIONS

This application is a 35 U.S.C. § 371 National Stage patent application of PCT/IB2022/057038, filed on 29 Jul. 2022, which claims the benefit of Italian patent application 102021000020687, filed 2 Aug. 2021, the disclosures of which are incorporated herein by reference in their entirety.

### TECHNICAL FIELD

The present disclosure relates to a method for maintaining a glasses frame.

### BACKGROUND

They are known in the state of the art methods for maintaining glasses frames wherein glasses frames are adapted and adjusted at two separate times. The first adjustment and adaptation of the frame takes place when a patient wears the glasses for the first time. The second adjustment and adaptation takes place at a second time when the patient returns because the glasses frame no longer properly fits due to wear or routine damage. In order to detect whether a frame has changed since the first adjustment, it is possible to measure five characteristics of the glasses: a front curve-face form angle α (FIG. 1), a pantoscopic angle θ (FIG. 2), a curling of a temple end curve (temple curl, FIG. 3), a maximum opening temple angle (FIG. 4), a temple wrap (FIG. 5).

Disadvantageously, the optician must independently analyse the problems of the frame and must be highly skilled in the field.

### SUMMARY

The present disclosure creates a method for maintaining a glasses frame that enables to automatically detect problems in the frame due to wear or damage and that provides indications on how to solve said problems.

According to the disclosure, this is achieved by providing a method for maintaining a glasses frame according to an independent claim.

The present disclosure also creates a computer programme that implements a method for maintaining a glasses frames that enables to automatically detect problems in the frame due to wear or damage and that provides instructions on how to solve said problems.

According to the disclosure, this is achieved by providing a computer programme according to another independent claim.

Other features are provided in the dependent claims.

### BRIEF DESCRIPTION OF THE DRAWINGS

The features and advantages present disclosure will be more apparent from the following description, which is to be understood as exemplifying and not limiting, with reference to the appended schematic drawings, in which:

FIG. 1 is a schematic view of a front curve-face form angle of a glasses frame;

FIG. 2 is a schematic view of a pantoscopic angle of the frame;

FIG. 3 is a schematic view of a curling of a temple curl of the frame;

FIG. 4 is a schematic view of a maximum opening temple angle;

FIG. 5 is a schematic view of a temple wrap; and

FIG. 6 shows a schematic view of a method for maintaining a glasses frame according to the present disclosure.

### DETAILED DESCRIPTION OF THE DRAWINGS

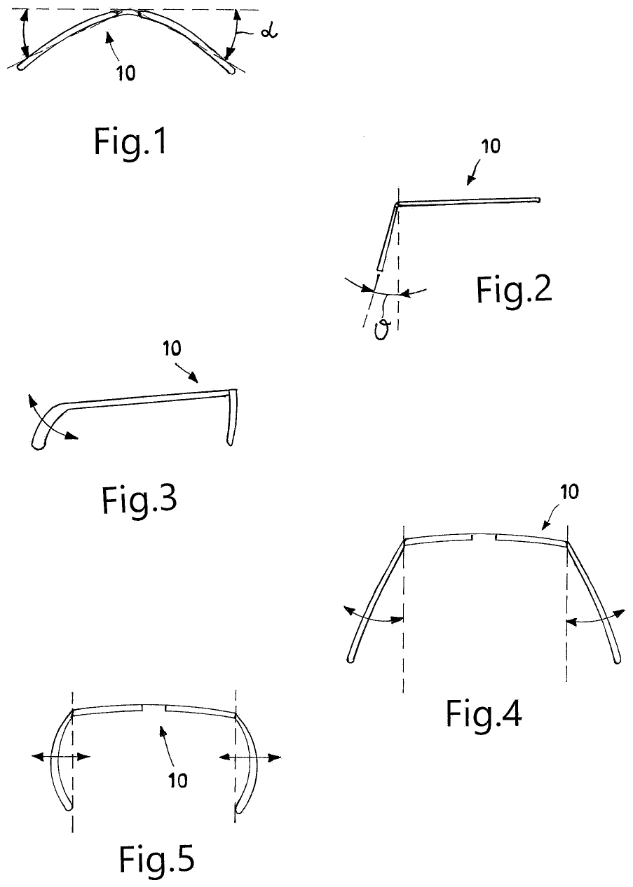

Before describing the figures, it should be noted that the five characteristics shown in FIGS. 1-5 are those most likely to be changed in a pair of glasses, however a list thereof must not be intended as limited, as it is possible to detect and modify even a smaller number of them (not necessarily all of them) or other characteristics and/or defects could be detected and/or modified, such as for example a scratched or broken lens, scratched frame, loosen screw, etcetera which are not detectable by 3D scanning. In this case (characteristics or defects not detectable by 3D scanning), the solution according to the disclosure may provide for a “manual” reporting of the characteristic or defect, for example by a user input (comments or buttons) in the app.

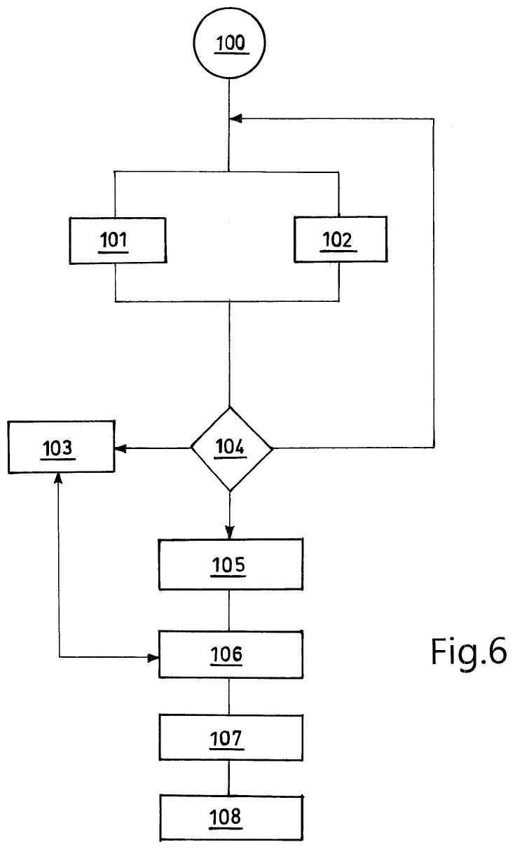

Referring to FIG. 6, a preferred embodiment of the method 100 according to the disclosure for maintaining glasses frames 10 is shown which comprises a step of carrying out a scanning 101, 102 of the frame 10 in a first configuration.

The frame scanning measures at least one of the frame 10 characteristics included in this list: a front curve-face form angle α, FIG. 1, a pantoscopic angle θ, FIG. 2, a curling of a temple curl, FIG. 3, a maximum opening temple angle, FIG. 4, a temple wrap, FIG. 5.

The first configuration of the frame 10 includes the characteristics of the frame 10 as arranged by the optician on delivery of the glasses.

Preferably the scanning 101, 102 measures all the characteristics of the frame 10.

The scanning 101, 102 may be carried out by means of a three-dimensional scanner owned by an optician or salesperson and thus we deal with a three-dimensional scan 101, or it may occur by means of an application that scans the frame 10, where said application is a software loaded onto an electronic device e.g. an application that runs on a patient's portable phone, in which case we deal with a scanning by a user device 102.

The step of carrying out the scanning 101, 102 comprises a sub-step of acquiring scanning data and measuring, from said data, at least one characteristic of the frame 10.

The characteristics of the frame are saved 103 in a data file as the first configuration. The data file may be a server-side electronic data file or a local data file of the optician or user application.

Should the patient notice problems with the frame 10, he/she could start a second scanning 101, 102 of the frame 10 saving 105 the characteristics of the frame 10 according to a second configuration. The method 100 compares 106 the first configuration with the second configuration and determines the differences 107 by indicating the problems detected 108 and providing an explanation on how to solve them, i.e. whether it is necessary to make an appointment with the salesperson or optician, whether it is possible to solve the problem independently, or whether it is possible to set a maintenance schedule, or whether it is necessary to change the frame 10.

The problems with the frame are differences between the first configuration and the second configuration due to wear or damage.

Advantageously, video tutorials may be available for the patient user to explain how to fix or adjust on one's own the characteristic of the frame 10 that has created problems and that is different between the second and first configuration.

The optician will repair, fix or adjust the frame 10 based on the analysis of the method 100.

The method 100 of the disclosure may be implemented in a computer program comprising a computer code running on an electronic computer performing operations of the method 100. The computer comprises at least a memory comprising the data file and a processor to implement 15 the actions of the method 100.

The computer programme can be loaded into the memory of the electronic computer and comprises instructions which, when the programme is executed by the computer, are implemented by the method 100.

The programme can be server-side and run remotely or on the electronic device of the user or optician.

In particular, FIG. 6 schematically illustrates the method 100 by allowing either a three-dimensional scanning 101 or a scanning via user device 102. The 25 method 100 checks 104 whether it is a first scanning by asking the user or by checking whether the frame characteristics have already been saved in the data file. If it is a first scanning, then the method 100 saves 103 the characteristics of the frame in the data file as the first configuration of the frame, otherwise the method 105 saves the characteristics of frame 10 in the data file as the second configuration of the frame 10. Subsequently, the method 100 compares 106 the first configuration previously saved in the data file with the second configuration, analyses the two configurations and determines the differences 107, indicates the problems detected 108 and provides an explanation on how to solve them.

Preferably, it is possible that the method 100 reports the problems detected to the optician or to the manufacturer of the frame 10, so that information can be obtained on the life expectancy, average life of the frame 10 for improving the characteristics of the frame 10.

Advantageously the patient user is favoured by this method 100 in that once the frame 10 has been purchased, he or she can independently check the state of health thereof and obtain information on any maintenance programmes or on the history of maintenance actions to be scheduled over time.

It is preferably foreseen that the first configuration of the frame 10 is detected 101 by the optician by means of a scanning with a three-dimensional scanner to be used by the optician or salesperson.

Advantageously, the patient may scan 102 the frame 10 of his/her glasses whenever he/she wishes, saving the second configuration in the data file so that the method 100 can verify the differences 107 that have occurred over time between the second configuration and the first configuration.

Checking 104 advantageously allows to save 103, 105 the characteristics of the frame 10 as a first configuration if it is an optimal configuration of the frame 10, or as a second configuration if it is a modified configuration of the frame 10, for example due to damage or wear of the frame 10.

Advantageously, the first configuration of the frame 10 is the one considered as the best by the patient user and/or optician. The optician or patient user may choose to save the configuration of the frame 10 as the first configuration in the data file, so that the method 100 can compare 106 the first configuration with a subsequent second configuration.

The characteristics of the first configuration of the frame 10 and/or subsequent second configurations may printed out and given to the patient user.

Preferably after maintenance, a new configuration is created, close to the original one but not identical. Consequently, it is preferable for the optician to update the reference configuration by saving it as the first configuration.

Preferably the first and second configurations of the frame 10 are kept saved in the data file as historical data, even when the patient user or optician decides to save new first or second configurations depending on the needs. Advantageously, the optician may receive information by means of a report of the method 100 on the second configuration of the frame 10 by the patient user so as to make an appointment, from remote, in order to solve the problem without the patient user having to physically go to the shop or optician, such that when the patient user goes to the shop or optician to solve the problem, waiting times can be reduced, or waiting times can be set in advance for a better patient user service.

Advantageously, the execution of the scanning 101, 102 provides that the computer program detects the scanning data by means of a three-dimensional scanner or mobile device application and the computer program detects the characteristics of the frame 10 from the scanning 101, 102.

In particular, the method 100 provides

The comparison 106 between the two scans classified as first and second frame configuration respectively.

Preferably, the comparison 106 is made by comparing the three-dimensional image of the first configuration with the three-dimensional image of the second configuration.

Preferably, the comparison 106 between the two scans of the first and second configuration is done by comparing one or more two-dimensional views of the first configuration with one or more two-dimensional views of the second configuration.

Two-dimensional views mean, for example, the view from the horizontal or side plane, wherein these two-dimensional views may be obtained from a three-dimensional model of the frame 10 or may be extracted as individual shots while scanning 101, 102 the frame 10.

The comparison 106 of two-dimensional images consists in analysing differences between the two images of the two configurations in terms of angles or point-to-point distance. For example, the opening temple angle in the first configuration and the opening temple angle in the second configuration is measured in degrees. Next, a difference between the angles of the first and second configuration is obtained. If this angle difference is greater than a certain predefined value, the defect is reported.

The comparison of three-dimensional images consists in analysing the differences between the two three-dimensional images in terms of angle or point-to-point distance or the average distance between point clouds. For example, given a point cloud of each first and second configuration, the average distance between point clouds is measured, and if this is greater than a certain predefined value in a given area, then the defect is reported.

Preferably the optician is reported how to fix the frame by visually showing the difference between the first and second configuration, or still more preferably by suggesting how to correct the defect, e.g. the programme may signal to increase the curvature of the temples or reduce the curvature of the temples, or for example increase the temple wrap angle or reduce the temple wrap angle. Preferably the suggestions may be proposed as texts and/or with images and/or short videos.

Alternatively, it is also possible to report additional problems not only related to the frame but also to the glasses lenses. For example, it is also possible for the user or optician to also report lens defects such as scratched lens, broken lens, or frame-related defects that cannot be scanned, such as a scratched frame, loosen screw. According to this alternative, the computer programme comprises a user interface for reporting further lens or frame defects, such as the defects outlined above, but also additional defects typical of glasses and well known to opticians.

The disclosure thus conceived is susceptible to many modifications and variants, all falling within the scope of the inventive concept. In practice, the materials used, as well as their dimensions, can be of any type according to the technical requirements.

1. A method for maintaining glasses frame the method including the following steps:
carrying out a scanning of said glasses frame, wherein the scanning measures at least one characteristic of the frame included in a list comprising a front curve-face form angle, a pantoscopic angle, a curling an end bend of a rod, a maximum opening angle of the rod, a rod bending;
saving in a data file said at least one characteristic of the glasses frame as the first configuration if it is an optimal configuration of the glasses frame, or as a second configuration if it is a modified configuration of the glasses frame;
comparing the first configuration with the second configuration;
analysing the two configurations and determining the differences; and
indicating problems detected between the two configurations, providing indications on how to solve them.

2. The method according to claim 1 implemented in a computer program comprising a computer code running on an electronic computer performing operations of the method, wherein said computer comprises at least one memory comprising the data file and a processor to implement the actions of the method.

3. The method according to claim 1, whereby the scanning is carried out with a three-dimensional scanner, classifying the scanning as a three-dimensional scanning.

4. The method according to claim 1, whereby the scanning is carried out with an application scanning the glasses frame, wherein said application is a computer program loaded on a device electronic.

5. The method according to claim 1, wherein the indications on how to solve the detected problems include at least one among making an appointment with a salesperson or an optician, an explanation on how solving the problems independently, a programming of a maintenance procedure, an indication of a need to change the glasses frame.

6. The method according to claim 1, further including the step of checking to verify if the scanning data is a first scanning by asking the user or by verifying whether the characteristics of the glasses frame have already been saved in the data file,
in case it is a first scanning, or in case it is a configuration of the glasses frame considered as optimal, then the method saves the characteristics of the glasses frame in the data file, listing the characteristics as the first configuration of the glasses frame,
otherwise the method saves the characteristics of the glasses frame in the data file as the second configuration of the glasses frame.

7. The method according to claim 1, further including a step of reporting the problems detected to the optician or to a manufacturer of the glasses frame.

8. The method according to claim 1, wherein the execution of the scanning includes a step of data scanning and measuring from said data of said at least one characteristic of the glasses frame.

9. A computer program loadable into the memory of an electronic computer comprising instructions which, when the program is executed by the computer, carry out a method according to claim 1.

10. The computer program according to claim 9, further comprising a user interface for signaling further lens or frame defects.
